(19) United States
(12) Patent Application Publication
(10) Pub. No.: US 2026/0276882 A1
(43) Pub. Date: Sep. 17, 2026

(54) ANTI-RESONANT HOLLOW CORE FIBER

(71) Applicant: Heraeus Quarzglas GmbH & Co. KG, Hanau (DE)

(72) Inventors: Tobias TIESS, Bitterfeld-Wolfen (DE); Manuel ROSENBERGER, Kleinostheim (DE)

(21) Appl. No.: 19/168,183

(22) PCT Filed: Feb. 29, 2024
(86) PCT No.: PCT/EP2024/055182

§ 371 Date: Sep. 23, 2025

(30) Foreign Application Priority Data
Mar. 28, 2023 (EP) 23164685.2

(51) Int. Cl. G02B 6/02

(52) U.S. Cl. CPC G02B 6/02328; G02B 6/02338

(57) ABSTRACT

An anti-resonant hollow core fiber, comprising a longitudinal axis and a core radius R_Faser, a cladding having a cladding inner bore, a number of anti-resonant units, each comprising an ARU external and internal unit, wherein the circular-arcuately designed external unit and the internal unit are connected to one another along two seam lines such that the internal unit at least partially projects into the external unit, the units are arranged spaced apart from one another and without contact with one another at target positions on a cladding inner side, wherein, in at least one anti-resonant unit, the ARU arc unit has a radius FB_R, and is connected to the internal unit. The following to apply to the ratio of twice the radius of the ARU arc unit FB_R to the fiber core radius R_Faser:

$$\frac{2 * FB\_R}{R\_Faser} = [ 0.7 ; 1.7 ] .$$

### BACKGROUND OF THE INVENTION

The invention relates to an anti-resonant hollow-core fiber.

### PRIOR ART

Hollow-core fibers have a core that comprises an evacuated cavity filled with gas or liquid. In hollow core fibers, there is less interaction between the light and the glass than in solid core fibers. The refractive index of the core is smaller than that of the surrounding cladding, so that light transmission by total reflection is not possible. Depending upon the physical mechanism of light transmission, hollow-core fibers are divided into “photonic band gap fibers” and “anti-resonance reflection fibers.”

In the embodiment variant of the hollow core fiber referred to as an “anti-resonant hollow core fiber” (ARHCF), the hollow core region is surrounded by an inner cladding region in which what are known as anti-resonant units (also known as “anti-resonant elements” or “ARU's”) are arranged. The walls of the anti-resonant units, which are uniformly distributed around the hollow core, can act as Fabry-Perot cavities operated with anti-resonance, which reflect the incident light and thus enable waveguiding in the fiber core.

This technology promises a hollow-core fiber with low optical attenuation, a very broad transmission spectrum (also in the UV or IR wavelength range), and low latency during data transmission.

WO 2022157179 A1 discloses an anti-resonant hollow core fiber in which the hollow core is surrounded by an inner cladding with anti-resonant units. These anti-resonant units have an ARU outer element and an ARU inner element inserted therein. Furthermore, circular arc elements can be arranged in the non-resonant elements. However, it has been found to be disadvantageous that, depending upon the design of the arc elements, the transmission properties of the fundamental mode and higher-order modes are unsuitable for applications, especially in the telecommunications sector. In this respect, reference is made to the application WO 2022157179 A1, the content of which is hereby incorporated into this application.

### Technical Problem

For industrial use, anti-resonant hollow core fibers with low attenuation are required. Furthermore, an anti-resonant hollow-core fiber is required that can be produced easily and on a large scale. This is the only way to bring the costs of anti-resonant hollow-core fibers within reasonable limits. It is important to note that anti-resonant hollow-core fibers that produce good results on a laboratory scale are not necessarily suitable for large-scale use.

An aim of the invention is to provide an anti-resonant hollow-core fiber which overcomes the above-mentioned disadvantages.

An aim of the invention is to provide an anti-resonant hollow-core fiber which can be produced precisely and reproducibly and additionally exhibits low attenuation.

In particular, one aim of the invention is to provide an anti-resonant hollow core fiber which has particularly low waveguiding losses.

In particular, one aim of the invention is to provide an anti-resonant hollow core fiber which efficiently attenuates higher-order modes.

### PREFERRED EMBODIMENT VARIANTS OF THE INVENTION

A contribution to the at least partial fulfillment of at least one of the aforementioned objects is made by the features of the independent claims. The dependent claims provide preferred embodiment variants that contribute to the at least partial fulfillment of at least one of the objects.

The following embodiment variants contribute at least partially to achieving at least one of the aforementioned objects:
   |1.| A first embodiment variant of an anti-resonant hollow core fiber, comprising a fiber longitudinal axis and a fiber core radius R_Faser, a fiber cladding having a cladding inner bore, a number of anti-resonant units,
   each comprising an ARU outer unit and an ARU inner unit,
   wherein the circular-arc-like ARU outer unit and the circular-arc-like ARU inner unit are connected to one another along two seam lines in such a way that the ARU inner unit at least partially projects into a first interior space of the ARU outer unit,
wherein the anti-resonant units are spaced apart from one another and are arranged without contact with one another at target positions on a cladding inner side, wherein,
   the ARU outer unit has a first circle radius FA_R and a first center angle FA_MW,
   the ARU inner unit has a second circle radius FI_R and a second center angle FI_MW,
wherein an amount by which the first circle radius FA_R deviates from the second circle radius FI_R is less than 10% of the first circle radius FA_R,
wherein,
   the first center angle FA_MW is less than 345° and greater than 275°, and
   the second center angle FI_MW is less than 195° and greater than 40°,
wherein, in at least one anti-resonant unit,
   an ARU arc unit is arranged in the first interior space,
   the ARU arc unit is circular,
   has a radius FB_R, and
   the ARU arc unit is connected to the ARU inner unit along a contact seam.

This embodiment variant is characterized by the fact that, for the ratio of twice the radius of the ARU arc unit FB_R to the fiber core radius R_Faser, the following applies

$$\frac{2 * FB\_R}{R\_Faser} = [ 0.7 ; 1.7 ]$$

   |2.| A further embodiment variant of an anti-resonant hollow core fiber having the features of the first embodiment variant is characterized in that, for the ratio of twice the radius of the ARU arc unit FB_R to the fiber core radius R_Faser, the following applies:
   2*FB_R/R_Faser is greater than or equal to 0.8, in particular greater than or equal to 0.9, in particular greater than or equal to 1.0; and
   2*FB_R/R_Faser is less than or equal to 1.6, in particular less than or equal to 1.5, in particular less than or equal to 1.45.
   |3.| A further embodiment variant of an anti-resonant hollow core fiber having the features of the first or second embodiment variant is characterized in that the anti-resonant unit has a fiber space height FH_Z1, and, for the ratio of the fiber space height FH_Z1 to the fiber core radius R_Faser, the following applies:

$$\frac{FH\_Z1}{R\_Faser} = [ 0.8 ; 1.4 ]$$

   |4.| A further embodiment variant of an anti-resonant hollow core fiber having the features of the third embodiment is characterized in that, for the ratio of the fiber space height FH_Z1 to the fiber core radius R_Faser, the following applies:
   FH_Z1/R_Faser is greater than or equal to 0.8, in particular greater than or equal to 0.85, in particular greater than or equal to 0.9, in particular greater than or equal to 0.95, in particular greater than or equal to 1.0, and
   FH_Z1/R_Faser is less than or equal to 1.4, in particular less than or equal to 1.35, in particular less than or equal to 1.3, in particular less than or equal to 1.2.
   |5.| A further embodiment variant of an anti-resonant hollow core fiber having the features of any of the preceding embodiment variants is characterized in that, for the ratio of the fiber space height FH_Z1 to twice the radius of the ARU arc unit FB_R, the following applies:

$$\frac{FH\_Z1}{2 * FB\_R} \leq 2.5 , in particular \leq 1.3$$

   |6.| A further embodiment variant of an anti-resonant hollow core fiber having the features of the fifth embodiment variant is characterized in that, for the ratio of the fiber space height FH_Z1 to twice the radius of the ARU arc unit FB_R, the following applies:
   FH_Z1/(2*FB_R) is less than or equal to 1.2, in particular less than or equal to 1.05, in particular less than or equal to 1.0, in particular less than or equal to 0.9, in particular less than or equal to 0.85, in particular less than or equal to 0.8; and
   FH_Z1/(2*FB_R) is greater than or equal to 0.1, in particular greater than or equal to 0.125, in particular greater than or equal to 0.15, in particular greater than or equal to 0.2, in particular greater than or equal to 0.4, in particular greater than or equal to 0.5.
   |7.| A further embodiment variant of an anti-resonant hollow core fiber comprising any of the previous embodiment variants is characterized in that each anti-resonant unit has an ARU arc unit arranged in the first interior space of each ARU outer unit.
   |8.| A further embodiment variant of an anti-resonant hollow core fiber, having the features of any of the preceding embodiment variants, is characterized in that the amount by which the first circle radius FA_R deviates from the second circle radius FI_R is less than 5% of the first circle radius FA_R, in particular less than 3%, in particular less than 2%, in particular less than 1%.
   |9.| A further embodiment variant of an anti-resonant hollow core fiber having the features of any of the preceding embodiment variants is characterized in that the anti-resonant hollow core fiber has three, four, five, six, seven, or eight anti-resonant units, in particular in that the anti-resonant hollow core fiber has an odd number of anti-resonant units.
   |10.| A further embodiment variant of an anti-resonant hollow core fiber having the features of any of the preceding embodiment variants is characterized in that the anti-resonant units are arranged asymmetrically on the inner surface of the cladding.
   |11.| A further embodiment variant of an anti-resonant hollow core fiber having the features of any of the preceding embodiment variants is characterized in that at least one of the anti-resonant units has at least one of the following features:
   the ARU outer unit and/or the ARU inner unit and/or the ARU arc unit comprises an amorphous solid body, in particular a glass, in particular quartz glass,
   the ARU outer unit and/or the ARU inner unit and/or the ARU arc unit consists of an amorphous solid body, in particular a glass, in particular quartz glass,
   the ARU outer unit and/or the ARU inner unit and/or the ARU arc unit are made of the same material, in particular comprise or consist of a glass having a refractive index of at least 1.4, in particular 1.4 to 3, in particular 1.4 to 2.8, and
   a wall thickness of the ARU outer unit and the ARU inner unit and the ARU arc unit are substantially the same.
   |12.| A further embodiment variant of an anti-resonant hollow core fiber having the features of any of the preceding embodiment variants is characterized in that the waveguiding losses of the anti-resonant hollow core fiber are at least a factor of 50 smaller than those of an anti-resonant hollow core fiber without an arc unit, with all other design parameters remaining the same.
   |13.| A further embodiment variant of an anti-resonant hollow core fiber having the features of any of the preceding embodiment variants is characterized in that the anti-resonant hollow core fiber has at least one of the following features:
   a fundamental attenuation of less than 1.0 dB/km, in particular of less than 0.5 dB/km, in particular of less than 0.25 dB/km, in particular less than 0.15 dB/km for a transported wavelength between 1.0 μm and 2.5 μm, and
   a fundamental attenuation of less than 1 dB/km for a transported wavelength of up to 0.8 μm.
   |14.| A further embodiment variant of an anti-resonant hollow core fiber having the features of any of the preceding embodiment variants is characterized in that the difference between the fundamental attenuation of a straight anti-resonant hollow core fiber and an anti-resonant hollow core fiber wound to a diameter of 10 mm is smaller than two orders of magnitude, in particular smaller than one order of magnitude, in particular smaller than half an order of magnitude.
   |15.| A further embodiment variant of an anti-resonant hollow core fiber having the features of any of the preceding embodiment variants is characterized in that, for the first circular radius FA_R and/or second circular radius FI_R, the following applies:
   this is less than 30 μm, in particular less than 20 μm, in particular less than 17.5 μm, in particular less than or equal to 16.5 μm, in particular less than or equal to 15.75 μm, and/or
   this is greater than 5 μm, in particular greater than 10 μm, in particular greater than or equal to 11.5 μm, in particular greater than or equal to 12.25 μm.
   |16.| A further embodiment variant of an anti-resonant hollow core fiber having the features of any of the preceding embodiment variants is characterized in that at least one ARU arc unit has at least one of the following features:
   the radius of the ARU arc unit FB_R is less than 15 μm, in particular less than 12.5 μm, in particular less than 11 μm, in particular less than 9.5 μm
   the radius of the ARU arc unit FB_R is greater than 0.75 μm, in particular greater than 1 μm, in particular greater than 2.5 μm.
   |17.| A further embodiment variant of an anti-resonant hollow core fiber having the features of any of the preceding embodiment variants is characterized in that at least one ARU arc unit has at least one of the following features:
   the first circle radius FA_R is less than 25 μm, in particular less than 15 μm,
   the first circle radius FA_R is greater than 5 μm, in particular greater than 7 μm,
   the first circle radius FA_R is less than or equal to 16.5 μm, in particular less than or equal to 15.75 μm,
   the first circle radius FA_R is greater than or equal to 11.5 μm, in particular greater than or equal to 12.25 μm,
   the first center angle FA_MW is less than 345°, in particular less than 340°; in particular less than 320°, in particular less than 310°,
   the first center angle FA_MW is greater than 220°, in particular greater than 250°, in particular greater than 270°, in particular greater than 280°.
   |18.| A further embodiment variant of an anti-resonant hollow core fiber having the features of any of the preceding embodiment variants is characterized in that at least one ARU inner unit has at least one of the following features:
   the second circle radius FI_R is less than 25 μm, in particular less than 15 μm,
   the second circle radius FI_R is greater than 5 μm, in particular greater than 7 μm,
   the second circle radius FI_R is less than or equal to 16.5 μm, in particular less than or equal to 15.75 μm;
   the second circle radius FI_R is greater than or equal to 11.5 μm, in particular greater than or equal to 12.25 μm,
   the second center angle FI_MW is less than 130°, in particular less than 120°, in particular less than 100°; and
   the second center angle FI_MW is greater than 40°, in particular greater than 50°.
   |19.| A further embodiment variant of an anti-resonant hollow core fiber having the features of any of the preceding embodiment variants is characterized in that at least one anti-resonant unit has at least one of the following features:
   a wall thickness of the ARU outer unit and/or the ARU inner unit and/or the ARU arc unit is between 0.1 μm and 2.5 μm, in particular between 0.15 μm and 1.5 μm, in particular between 0.25 μm and 0.75 μm, in particular between 0.35 μm and 0.65 μm, in particular 0.5 μm,
   for a signal wavelength of 1,550 nm in the first transmission window, a wall thickness of the ARU outer unit and/or the ARU inner unit and/or the ARU arc unit is between 0.35 μm and 0.65 μm, in particular between 0.4 μm and 0.6 μm, in particular 0.5 μm,
   for a signal wavelength of 1,550 nm in the second transmission window, a wall thickness of the ARU outer unit and/or the ARU inner unit and/or the ARU arc unit is between 0.75 μm and 1.25 μm, in particular between 0.9 μm and 1.1 μm, in particular 1 μm.

### DETAILED DESCRIPTION

Some of the features described are associated with the term “substantially.” The term “substantially” is to be understood in such a way that, under real conditions and manufacturing techniques, a mathematically exact interpretation of terms such as “superimposition,” “perpendicular,” “diameter,” or “parallelism” can never be given exactly, but only within certain manufacturing error tolerances. For example, “substantially parallel axes” form an angle of −5 degrees to 5 degrees relative to one another, and “substantially equal volumes” include a variation of up to 5 vol. %. For example, a “device consisting substantially of quartz glass” comprises a quartz glass content of ≥95 to ≤100 wt. %. Furthermore, “substantially perpendicular” includes an angle of 85 degrees to 95 degrees. A further specification of the term “substantially” is provided below for some features.

The aforementioned objects are at least partially achieved by an anti-resonant hollow core fiber comprising a fiber longitudinal axis and a fiber core radius R_Faser, a fiber cladding having a cladding inner bore, a number of anti-resonant units,
each comprising an ARU outer unit and an ARU inner unit,
wherein the circular-arc-like ARU outer unit and the circular-arc-like ARU inner unit are connected to one another along two seam lines in such a way that the ARU inner unit at least partially projects into a first interior space of the ARU outer unit,
   wherein the anti-resonant units are spaced apart from one another and are arranged without contact with one another at target positions on a cladding inner side, wherein,
the ARU outer unit has a first circle radius FA_R and a first center angle FA_MW,
the ARU inner unit has a second circle radius FI_R and a second center angle FI_MW,
   wherein an amount by which the first circle radius FA_R deviates from the second circle radius FI_R is less than 10% of the first circle radius FA_R,
the first center angle FA_MW is less than 345° and greater than 275°, and
the second center angle FI_MW is less than 195° and greater than 40°,
   wherein, in at least one anti-resonant unit,
an ARU arc unit is arranged in the first interior space,
the ARU arc unit is circular,
has a radius FB_R, and
the ARU arc unit is connected to the ARU inner unit along a contact seam.

According to the invention, the following applies for the ratio of twice the radius of the ARU arc unit FB_R to the fiber core radius R_Faser:

$$\frac{2 * FB\_R}{R\_Faser} = [ 0.7 ; 1.7 ]$$

Twice the radius of the ARU arc unit FB_R corresponds to the diameter of the ARU arc unit. This type of anti-resonant hollow core fiber exhibits an improved fundamental mode over shorter travel distances, since the higher-order modes in the core couple particularly efficiently with the highly lossy modes in the ARU arc unit.

“Fundamental mode” is understood to mean that the fundamental mode has more than 95%, in particular more than 97.7%, of the power transported in the fiber core. In this respect, rapid achievement of the fundamental mode is equivalent to the higher-order modes running in the fiber core being attenuated to such a degree over a short travel distance, in particular over a travel distance of less than 20 m, in particular less than 10 m, in particular less than 5 m, that more than 95%, in particular more than 97.7%, of the power transported in the fiber core is available in the fundamental mode.

In general, anti-resonant hollow core fibers (hereafter also called ARHCF's) have a silica sheath and an air-filled cladding inner bore (also air core), which leads to a special light propagation mechanism. ARHCF's follow the light transmission mechanisms of anti-resonant reflecting optical waveguiding (ARROW) and not the principle of total internal reflection of single mode fibers (SMF).

The ARROW light propagation mechanism utilizes coherent reflections at the air-silica interfaces, often in combination with an arrangement of anti-resonant units around a central hollow core, to effectively confine and guide the forward-propagating light within the central hollow core. In order to represent the propagation of light in the ARHCF in simulations, the hollow core capillary having regular silica cladding is chosen as the representative for describing the anti-resonance theory. The hollow core capillary with regular ring cladding can be considered a Fabry-Perot resonant cavity in the radial direction. This Fabry-Perot resonant cavity enables the transmission of the optical frequencies in the fiber core that do not resonate with the core wall. These optical frequencies are reflected back to the fiber core, where they propagate with low loss. On the other hand, the optical resonance frequencies cannot be confined in the fiber core and escape radially into the cladding region.

The loss of ARHCF's consists mainly of scattering losses and waveguiding losses:
The scattering losses are mainly divided into material scattering losses in all elements and surface scattering losses.
   The surface scattering losses are caused, among other things, by the surface roughness of the cladding inner bore and the ARU outer units. These surface roughnesses are significantly influenced by the thermodynamic process during fiber production.
   Material losses occur in every region of the ARHCF. This includes not only the hollow core, but also the glass region. Furthermore, the coating surrounding the silica cladding can contribute thereto.
   The scattering losses are substantially independent of the design chosen for the ARHCF.
The waveguiding losses result from—among other things—the arrangement of anti-resonant units around a central hollow core.

The transmission ranges of the ARHCF are spectrally specified by the anti-resonant regions of the irregular cladding. A combination of antiresonance and suppression of the coupling between the core modes and the sheath modes is crucial for the light transmission principle of ARHCF.

The coupling of the different modes with one another significantly influences the use of the ARHCF in data centers, for example. For the following description and/or simulation, the following modes were taken into consideration:
fundamental mode in the core
   also called core fundamental modes;
higher-order modes in the core
   also called higher-order core modes (HOM),
   wherein only the second-order modes (i.e., the first-order modes above the fundamental mode) have been taken into consideration in the simulations;
modes in the ARU outer unit
   also called anti-resonant unit modes or ARU modes,
   wherein, in the simulations, only the fundamental mode in the ARU outer units has been taken into consideration;
modes in the ARU arc unit
   also called arc unit modes or DNE modes,
   wherein, in the simulations, only the fundamental mode in the ARU arc units has been taken into consideration.

Surprisingly, it was found that the geometry of the ARU arc unit can have a significant influence on the conduction behavior of an ARHCF. With the described dimensions of the ARU arc unit, it is possible to phase-match the higher-order modes in the core with those in the ARU arc unit. This effect is desirable and results in higher-order modes in the core coupling with the more lossy arc unit modes. The resulting loss mechanism attenuates the higher-order modes in the core in addition to the inherent waveguiding losses, so that the ARHCF can be effectively operated in the core fundamental mode.

Both the ARU outer unit and the ARU inner unit are circular-arc-like. Deviations of the ARU outer unit wall and/or ARU inner unit wall from the ideal circular-arc shape are based in particular upon manufacturing-related variations. In particular, the first circle radius FA_R and/or the second circle radius FI_R may not deviate by more than 10%, in particular not more than 5%, in particular not more than 2.5%, from the mean first circle radius FA_R and/or mean second circle radius FI_R, in particular both azimuthally over a circular arc—so that an elliptical course is created—and at axially different points of the ARHCF.

The ARU arc unit is circular. Deviations of the radius FB_R of the ARU arc unit from the ideal circular shape are based in particular upon manufacturing-related variations. In particular, the radius FB_R of the ARU arc unit may not deviate by more than 10%, in particular not more than 5%, in particular not more than 2.5%, from a mean radius FB_R of the ARU arc unit, in particular both azimuthally over a circle—so that an elliptical course is created—and at axially different points of the ARHCF.

A further embodiment variant is characterized in that the fiber core radius R_Faser is less than 30 μm, in particular less than 25 μm and in particular less than 20 μm. A further embodiment variant is characterized in that the fiber core radius is greater than 5 μm, in particular greater than 10 μm, in particular greater than 15 μm. In particular, the anti-resonant hollow core fiber can have a fiber core radius R_Faser of 17.25 μm. The listed fiber core radii R_Faser represent an advantageous embodiment variant insofar as
the waveguide losses of the fundamental mode in the core decrease with increasing first circle radius FA_R, but
the bending sensitivity of the ARHCF increases significantly with increasing first circle radius FA_R.

Accordingly, the listed fiber core radii R_Faser result in an ARHCF that exhibits both low waveguide losses of the fundamental mode and good bending sensitivity.

A further embodiment variant is characterized by the fact that, for the ratio of twice the radius of the ARU arc unit FB_R to the fiber core radius R_Faser, the following applies:
2*FB_R/R_Faser is greater than or equal to 0.8, in particular greater than or equal to 0.9, in particular greater than or equal to 1.0; and
2*FB_R/R_Faser is less than or equal to 1.6, in particular less than or equal to 1.5, in particular less than or equal to 1.45.

This type of anti-resonant hollow core fiber has a particularly short travel distance until the fundamental mode is reached.

A further embodiment variant is characterized in that the anti-resonant unit has a fiber space height FH_Z1 and, for the ratio of the fiber space height FH_Z1 to fiber core radius R_Faser, the following applies:

$$\frac{FH\_Z1}{R\_Faser} = [ 0.8 ; 1.4 ]$$

Surprisingly, it was found that the geometry of the ARU arc unit in comparison to the geometry of the ARU outer unit can have a significant influence on the conduction behavior of an ARHCF. In an ARHCF having at least one anti-resonant unit with the specified parameter, the higher-order modes in the core couple particularly effectively with the ARU modes and/or DNE modes. As a result, the higher-order modes in the core are attenuated, and the hollow core fiber is in the fundamental mode over a shorter travel distance.

A further embodiment variant is characterized by the fact that, for the ratio of the fiber space height FH_Z1 to fiber core radius R_Faser, the following applies:
FH_Z1/R_Faser is greater than or equal to 0.8, in particular greater than or equal to 0.85, in particular greater than or equal to 0.9, in particular greater than or equal to 0.95, in particular greater than or equal to 1.0, and
FH_Z1/R_Faser is less than or equal to 1.4, in particular less than or equal to 1.35, in particular less than or equal to 1.3, in particular less than or equal to 1.2.

The specified ranges allow for further optimization of the coupling between higher-order modes in the core and the ARU modes and/or DNE modes. Thus, the travel distance within which the hollow core fiber enters the fundamental mode is further shortened.

Surprisingly, it was found that the geometry of the ARU arc unit influences not only the fundamental mode, but also the attenuation of the ARHCF. A further embodiment variant is characterized by the fact that, for the ratio of the fiber space height FH_Z1 to twice the radius of the ARU arc unit FB_R, the following applies:

$$\frac{FH\_Z1}{2 * FB\_R} \leq 2.5 , in particular \leq 1.3$$

Twice the radius of the ARU arc unit FB_R corresponds to the diameter of the ARU arc unit. This embodiment variant is characterized by particularly low attenuation of the fundamental mode.

A further embodiment variant is characterized by the fact that, for the ratio of the fiber space height FH_Z1 to twice the radius of the ARU arc unit FB_R, the following applies:
FH_Z1/(2*FB_R) is less than or equal to 1.2, in particular less than or equal to 1.05, in particular less than or equal to 1.0, in particular less than or equal to 0.9, in particular less than or equal to 0.85, in particular less than or equal to 0.8; and
FH_Z1/(2*FB_R) is greater than or equal to 0.1, in particular greater than or equal to 0.125, in particular greater than or equal to 0.15, in particular greater than or equal to 0.2, in particular greater than or equal to 0.4, in particular greater than or equal to 0.5.

The specified intervals allow for further optimization of the attenuation of the fundamental mode.

A further embodiment variant is characterized in that each anti-resonant unit has an ARU arc unit arranged in the first interior space of each ARU outer unit. The use of one ARU arc unit in each anti-resonant unit of the hollow core fiber results in improved coupling between higher-order modes in the core and the DNE modes.

Another embodiment variant is characterized in that the amount by which the first circle radius FA_R deviates from the second circle radius FI_R is less than 5% of the first circle radius FA_R, in particular less than 3%, in particular less than 2%, in particular less than 1%. For production reasons, it is complex to reduce the deviation between the first circle radius FA_R of the ARU outer unit and the second circle radius FI_R of the ARU inner unit. Only through efficient and precise hot processes can tubes, especially made of quartz glass, be produced that meet these requirements. This embodiment variant leads to a further reduction in the scattering losses in the ARHCF.

A further embodiment variant is characterized in that the anti-resonant hollow-core fiber has three, four, five, six, seven, or eight anti-resonance units, in particular in that the anti-resonant hollow-core fiber has an odd number of anti-resonance units. This embodiment enables further optimization of the attenuation of the fundamental mode.

A further embodiment variant is characterized in that the anti-resonance units are arranged asymmetrically on the internal surface area of the cladding. As a result, the higher-order modes in the core are attenuated, and the hollow-core fiber is in fundamental mode over a shorter travel distance.

A further embodiment variant is characterized in that at least one of the anti-resonant units has at least one of the following features:
the ARU outer unit and/or the ARU inner unit and/or the ARU arc unit comprises an amorphous solid body, in particular a glass, in particular quartz glass,
the ARU outer unit and/or the ARU inner unit and/or the ARU arc unit consists of an amorphous solid body, in particular a glass, in particular quartz glass,
the ARU outer unit and/or the ARU inner unit and/or the ARU arc unit are made of the same material, in particular comprise or consist of a glass having a refractive index of at least 1.4, in particular 1.4 to 3, in particular 1.4 to 2.8, and
a wall thickness of the ARU outer unit and the ARU inner unit and the ARU arc unit are substantially the same.

These embodiment variants of the anti-resonant units are optimized for low-loss transmission of signals at a wavelength of between 1.0 μm and 2.5 μm.

A further embodiment variant is characterized in that the waveguiding losses of the anti-resonant hollow core fiber are at least a factor of 50 smaller than those of an anti-resonant hollow core fiber without an arc unit, but where all the other design parameters remain the same. The ARU arc unit described in the embodiment variants makes possible that
coupling of the fundamental mode in the core with the ARU and/or DNE modes is only minimal, but at the same time
the higher-order modes in the core effectively couple with the more lossy ARU and DNE modes.

This results in an ARHCF which, on the one hand, enters the fundamental mode over a short travel distance and, on the other, simultaneously has only low attenuation of the fundamental mode.

A further embodiment is characterized in that the anti-resonant hollow-core fiber has at least one of the following features:
a fundamental attenuation of less than 1.0 dB/km, in particular of less than 0.5 dB/km, in particular of less than 0.25 dB/km, in particular less than 0.15 dB/km, for a transported wavelength between 1.0 μm and 2.5 μm, and
a fundamental attenuation of less than 1 dB/km for a transported wavelength of up to 0.8 μm.

This embodiment variant of the ARHCF is particularly suitable for use in data centers due to the low attenuation of the fundamental mode.

A further embodiment variant is characterized in that a fundamental attenuation difference between a straight anti-resonant hollow core fiber and an anti-resonant hollow core fiber wound to a diameter of 10 mm is smaller than two orders of magnitude, in particular smaller than one order of magnitude, in particular smaller than half an order of magnitude.

A further embodiment variant is characterized in that, for the first circle radius FA_R, the following applies:
this is less than 30 μm, in particular less than 20 μm, in particular less than 17.5 μm, in particular less than or equal to 16.5 μm, in particular less than or equal to 15.75 μm, and/or
this is greater than 5 μm, in particular greater than 10 μm, in particular greater than or equal to 11.5 μm, in particular greater than or equal to 12.25 μm.

This results in an ARHCF which has only low attenuation of the fundamental mode.

A further embodiment variant is characterized in that at least one ARU outer unit has at least one of the following features:
the first circle radius FA_R is less than 25 μm, in particular less than 15 μm,
the first circle radius FA_R is greater than 5 μm, in particular greater than 7 μm,
the first circle radius FA_R is less than or equal to 16.5 mm, in particular less than or equal to 15.75 mm,
the first circle radius FA_R is greater than or equal to 11.5 μm, in particular greater than or equal to 12.25 μm,
the first center angle FA_MW is less than 345°, in particular less than 340°; in particular less than 320°, in particular less than 310°,
the first center angle FA_MW is greater than 220°, in particular greater than 250°, in particular greater than 270°, in particular greater than 280°.

This results in an ARHCF which, on the one hand, becomes fundamental mode over a short travel distance and, on the other, has only low attenuation of the fundamental mode.

A further embodiment variant is characterized in that the at least one ARU inner unit has at least one of the following features:
the second circle radius FI_R is less than 25 μm, in particular less than 15 μm,
the second circle radius FI_R is greater than 5 μm, in particular greater than 7 μm,
the second circle radius FI_R is less than or equal to 16.5 μm, in particular less than or equal to 15.75 μm;
the second circle radius FI_R is greater than or equal to 11.5 μm, in particular greater than or equal to 12.25 μm,
the second center angle FI_MW is less than 130°, in particular less than 120°, in particular less than 100°; and
the second center angle FI_MW is greater than 40°, in particular greater than 50°.

This results in an ARHCF which, on the one hand, becomes fundamental mode over a short travel distance and, on the other, has only low attenuation of the fundamental mode.

A further embodiment variant is characterized in that at least one ARU arc unit has at least one of the following features:
the radius of the ARU arc unit FB_R is less than 15 μm, in particular less than 12.5 μm, in particular less than 11 μm, in particular less than 9.5 μm,
the radius of the ARU arc unit FB_R is greater than 0.75 μm, in particular greater than 1 μm, in particular greater than 2.5 μm.

This results in an ARHCF which becomes fundamental over a short travel distance.

A further embodiment variant is characterized in that at least one of the anti-resonant units has at least one of the following features:
a wall thickness of the ARU outer unit and/or the ARU inner unit and/or the ARU arc unit is between 0.1 μm and 2.5 μm, in particular between 0.15 μm and 1.5 μm, in particular between 0.25 μm and 0.75 μm, in particular between 0.35 μm and 0.65 μm, in particular 0.5 μm,
for a signal wavelength of 1,550 nm in the first transmission window, a wall thickness of the ARU outer unit and/or the ARU inner unit and/or the ARU arc unit is between 0.35 μm and 0.65 μm, in particular between 0.4 μm and 0.6 μm, in particular 0.5 μm,
for a signal wavelength of 1,550 nm in the second transmission window, a wall thickness of the ARU outer unit and/or the ARU inner unit and/or the ARU arc unit is between 0.75 μm and 1.25 μm, in particular between 0.9 μm and 1.1 μm, in particular 1 μm.

For an ARHCF, which in particular has an ARU arc unit having the specified wall thickness, and in particular for a transported wavelength of between 1.0 μm and 2.5 μm, the higher-order modes in the core particularly effectively couple with the DNE modes, which are more lossy. As a result, the higher-order modes in the core are attenuated, and the hollow-core fiber is in fundamental mode over a shorter travel distance.

The properties and features disclosed in the description may be essential for various embodiments of the claimed invention, both separately and in any combination with one another.

The invention is further illustrated by way of example below by means of figures. The invention is not limited to the figures.

### FIGURES

Shown are:

FIG. 1 a circular-arc-like ARU outer unit,

FIG. 2 a circular-arc-like shaped ARU inner unit,

FIG. 3 a circular ARU arc unit,

FIG. 4 part of an anti-resonant unit and an enlarged detail of a seam line,

FIG. 5 an anti-resonant unit and an enlarged detail of a contact seam,

FIG. 6 a cross-section through a part of an anti-resonant hollow core fiber,

FIG. 7 a cross-section through an anti-resonant hollow core fiber,

FIG. 8 a diagram of an effective mode index Δ neff (DNE), plotted against the ratio of twice the radius of the ARU arc unit FB_R to the fiber core radius R_Faser,

FIG. 9 a diagram of an effective mode index Δ neff (ARU), plotted against the ratio of fiber space height FH_Z1 to fiber core radius R_Faser,

FIG. 10 a diagram of the difference in waveguide losses between the fundamental mode and the higher order mode in the core, plotted against the ratio of the fiber space height FH_Z1 to the fiber core radius R_Faser,

FIG. 11 a diagram of the waveguide loss of the fundamental mode as a function of the ratio of the fiber space height FH_Z1 to twice the radius of the ARU arc unit FB_R, and

FIG. 12 another diagram of the effective mode index Δ neff (DNE), plotted against the ratio of twice the radius of the ARU arc unit FB_R to the fiber core radius R_Faser.

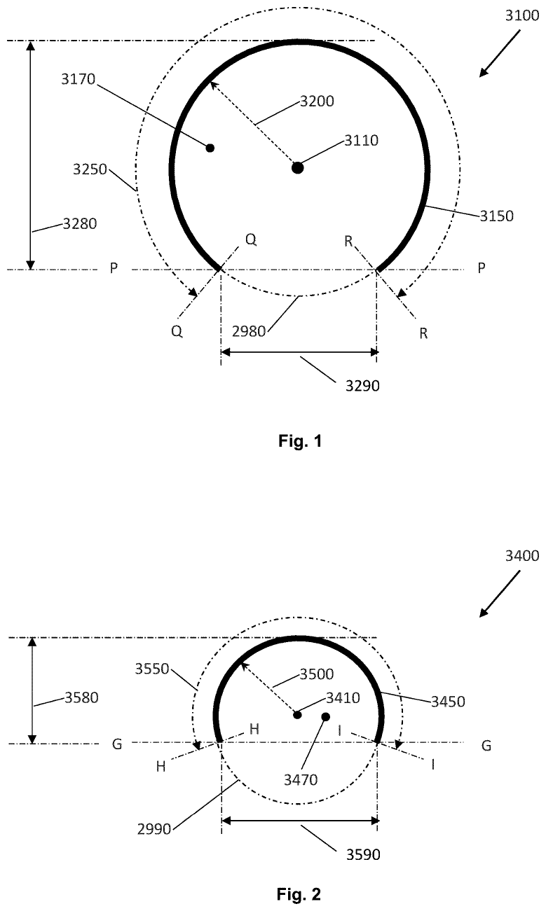

FIG. 1 shows a cross-section through an ARU outer unit 3100. The ARU outer unit 3100 is a tubular structure that has a circular-arc-like cross-section. The ARU outer unit 3100 extends along a first body longitudinal axis 3110. In FIG. 1, the ARU outer unit 3100 therefore extends into the plane of the drawing.

The ARU outer unit 3100 has an ARU outer unit wall 3150. In particular, the ARU outer unit wall 3150 may comprise or consist of a material that is transparent to the working light of the optical fiber, e.g., glass, in particular doped or undoped quartz glass (SiO2).

In one embodiment variant, the ARU outer unit wall 3150 has a wall thickness of between 0.25 μm and 0.75 μm, in particular between 0.35 μm and 0.65 μm, in particular 0.5 μm.

As the cross-section shown in FIG. 1 illustrates, the ARU outer unit 3100 has a circular-arc-like cross-section. In the context of the invention, the term “circular arc” refers to a portion of a circular line. Two points on a circle divide the circle line into two circular arcs. In the context of this invention, an element is described as “circular-arc-like” if its outer shape follows the course of one of the said two circular arcs. To illustrate this, a first circle 2980 is drawn in FIG. 1. This first circle 2980 is divided into two circular arcs by the two intersection lines Q-Q and R-R. The cross-section of the ARU outer unit 3100 follows one of the two circular arcs.

Furthermore, an intersection line P-P is drawn, which runs through the two points where the two intersection lines Q-Q and R-R intersect the circle 2980. The first chord of the ARU outer unit 3100 is the distance that lies on the intersection line P-P and is delimited by the intersection lines Q-Q and R-R. The first chord length 3290 is the length of the first chord.

The ARU outer unit 3100 has a first circle radius FA_R 3200. This first circle radius FA_R 3200 describes the distance between the ARU outer unit wall 3150 and the first body longitudinal axis 3110.

The ARU outer unit 3100 has a first segment height 3280. This first segment height 3280 describes the length of a straight line that is perpendicular to the first chord and runs up to the vertex of the ARU outer unit wall 3150.

The ARU outer unit 3100 has a first center angle FA_MW 3250. This first center angle FA_MW 3250 describes the angle whose vertex lies in the center of the first circle 2980 and whose sides intersect the boundary points of the circular arc (here, the points where the first circle 2980 intersects the intersection lines Q-Q and R-R). A full circle has a degree value of 360°. Since the ARU outer unit 3100 is circular-arc-like, the first center angle FA_MW 325 is less than 360°.

The ARU outer unit 3100 has a first interior space 3170 that is delimited by the ARU outer unit wall 3150 and the first chord.

In one embodiment variant, the ARU outer unit 3100 may have at least one of the following features:
the first circle radius FA_R 3200 is less than 25 μm, in particular less than 15 μm,
the first circle radius FA_R 3200 is greater than 5 μm, in particular greater than 7 μm,
the first circle radius FA_R 3200 is less than or equal to 16.5 μm, in particular less than or equal to 15.75 μm,
the first circle radius FA_R 3200 is greater than or equal to 11.5 μm, in particular greater than or equal to 12.25 μm,
the first center angle 3250 FA_MW is less than 345°, in particular less than 340°; in particular less than 320°, in particular less than 310°,
the first center angle 3250 FA_MW is greater than 220°, in particular greater than 250°, in particular greater than 270°, in particular greater than 280°.

FIG. 2 shows a cross-section through an ARU inner unit 3400. The ARU inner unit 3400 is a tubular structure that has a circular-arc-like cross-section. The ARU inner unit 3400 extends along a second body longitudinal axis 3410. In FIG. 2, the ARU inner unit 3400 therefore extends into the drawing plane.

The ARU inner unit 3400 has an ARU inner unit wall 3450. In particular, the ARU inner unit wall 3450 may comprise or consist of a material that is transparent to the working light of the optical fiber, e.g., glass, in particular doped or undoped quartz glass (SiO2). In one embodiment variant, the ARU inner unit wall 3450 has a wall thickness of between 0.25 μm and 0.75 μm, in particular between 0.35 μm and 0.65 μm, in particular 0.5 μm.

The ARU inner unit 3400 has a circular-arc-like cross-section. To illustrate this, a second circle 2990 is drawn in FIG. 2. This second circle 2990 is divided into two circular arcs by the two intersection lines H-H and I-I. The cross-section of the ARU inner unit 3400 follows one of the two circular arcs.

Furthermore, an intersection line G-G is drawn, which runs through the two points where the two intersection lines H-H and I-I intersect the second circle 2990. The second chord of the ARU inner unit 3400 is the stretch that lies on the intersection line G-G and is delimited by the intersection lines H-H and I-I. The second chord length 3590 is the length of the second chord.

The ARU inner unit 3400 has a second segment height 3580. This second segment height 3580 describes the length of a straight line that is perpendicular to the second chord and runs up to the vertex of the ARU inner unit wall 3450.

Furthermore, the ARU inner unit 3400 has a second circle radius FI_R 3500. This second circle radius FR_R 3500 describes the distance between the ARU inner unit wall 3450 and the second body longitudinal axis 3410.

The ARU inner unit 3400 has a second center angle FI_MW 3550. This second center angle FI_MW 3550 describes the angle whose vertex lies in the center of the second circle 2990 and whose sides intersect the boundary points of the circular arc (here, the points where the second circle 2990 intersects the intersection lines H-H and I-I). A full circle has a degree value of 360°. Since the ARU inner unit 3400 is circular-arc-shaped, the second center angle FI_MW 3550 is less than 360°.

The ARU inner unit 3400 has a second interior space 3470 that is delimited by the ARU inner unit wall 3450 and the second chord.

FIGS. 1 and 2 show a cross-section, i.e., an axial plan view of the ARU outer unit 3100 and the ARU inner unit 3400. In the two-dimensional view of each of the body longitudinal axes 3110 and 3410 shown, the ARU outer unit 3100 and the ARU inner unit 3400 have a circular-arc-like cross-section, which in a three-dimensional view corresponds to a tubular structural element.

The circular arc of the ARU outer unit 3100 and/or the ARU inner unit 3400 are substantially circular, wherein in particular the first circular radius FA_R 3200 and/or the second circular radius FI_R 3500 does/do not fluctuate by more than 10%, preferably more than 5%, more preferably more than 3% over the circumference of the ARU outer unit 3100 and/or the ARU inner unit 3400.

In one embodiment variant, the ARU inner unit 3400 can have at least one of the following features:
the second circle radius FI_R 3500 is less than 25 μm, in particular less than 15 μm,
the second circle radius FI_R 3500 is greater than 5 μm, in particular greater than 7 μm,
the second circle radius FI_R 3500 is less than or equal to 16.5 μm, in particular less than or equal to 15.75 μm;
the second circle radius FI_R 3500 is greater than or equal to 11.5 μm, in particular greater than or equal to 12.25 μm,
the second center angle FI_MW 3550 is less than 130°, in particular less than 120°, in particular less than 100°; and
the second center angle FI_MW 3550 is greater than 40°, in particular greater than 50°.

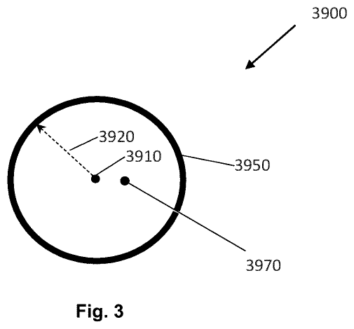

FIG. 3 shows an ARU arc unit 3900, which is a tubular structure. The ARU arc unit 3900 extends along a third body longitudinal axis 3910. In FIG. 3, the ARU arc unit 3900 therefore extends into the drawing plane.

The ARU arc unit 3900 has an arc wall 3950. In particular, the arc wall 3950 may comprise or consist of a material which is transparent to the working light of the optical fiber, e.g., glass, in particular doped or non-doped quartz glass (SiO2).

In one embodiment variant, the arc wall 3950 has a wall thickness of between 0.25 μm and 0.75 μm, in particular between 0.35 μm and 0.65 μm, in particular 0.5 μm.

The ARU arc unit 3900 has a radius FB_R 3920. This radius FB_R 3920 describes the distance between the arc wall 3950 and the first body longitudinal axis 3910. The ARU arc unit 3900 has a third interior space 3970 that is delimited by the arc wall 3950.

In one embodiment variant, the ARU arc unit 3900 may have at least one of the following features:
the radius of the ARU arc unit FB_R 3920 is less than 15 μm, in particular less than 12.5 μm, in particular less than 11 μm, in particular less than 9.5 μm,
the radius of the ARU arc unit FB_R 3920 is greater than 0.75 μm, in particular greater than 1 μm, in particular greater than 2.5 μm.

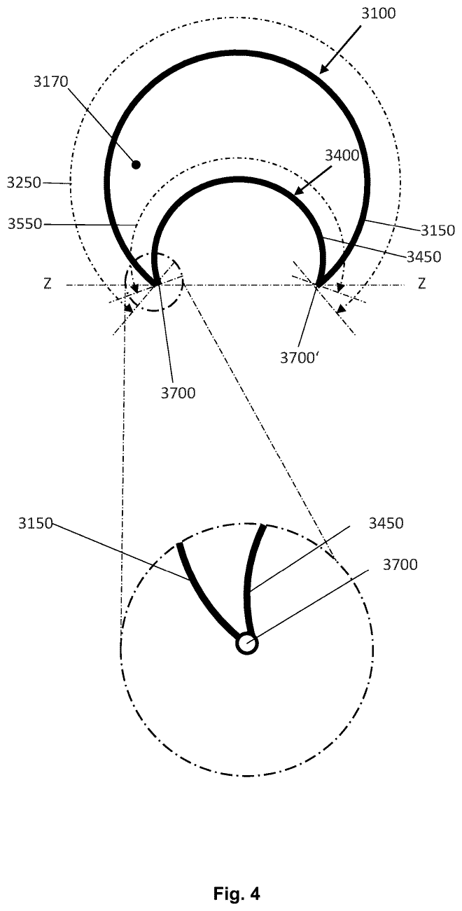

FIG. 4 shows parts of a hollow core fiber comprising the ARU outer unit 3100 and the ARU inner unit 3400, as shown in FIGS. 1 and 2. The ARU outer unit 3100 has a first interior space 3170 which is at least partially delimited by the ARU outer unit wall 3150. The circular-arc-like ARU inner unit 3400 protrudes at least partially into the first interior space 3170. This means that—in cross-section—the ARU inner unit 3400 extends substantially above the first chord of the ARU outer unit 3100.

The circular-arc-like ARU outer unit 3100 and the circular-arc-like ARU inner unit 3400 are connected to one another along two connection seams 3700, 3700′ arranged substantially in parallel with the first body longitudinal body axis 3110. In particular, this bond may have been achieved by a hot process.

To illustrate this, a region around the connection seam 3700 is shown enlarged in FIG. 4. The connection is formed between
a first end point of the ARU outer unit wall 3150 of the ARU outer unit 3100, and
a second end point of the ARU inner unit wall 3450 of the ARU inner unit 3400.

Since FIG. 4 shows a cross-section, the two connection seams 3700, 3700′ in the three-dimensional hollow core fiber 1000 extend into the drawing plane.

Due to manufacturing-related variations, it may happen that—particularly in some regions—the first end point of the ARU outer unit wall 3150 does not exactly coincide with the second end point of the ARU inner unit wall in order to form the connection seams 3700, 3700′. In particular, two deviations from this positioning of the ARU inner unit 3400 can occur due to manufacturing-related variations:
1. The first end point—in particular regions thereof—of the ARU outer unit wall 3150 can be arranged on the ARU inner unit wall 3450 of the ARU inner unit 3400, and the ARU inner unit 3400 can thus partially protrude from the first interior space 3170. In this case, the ARU inner unit 3400 can only be partially integrally bonded to the inner surface 2150 of the cladding 2000. The latter may depend upon the proportion of the second center angle FI_MW that protrudes from the first interior space 3170. In particular, no more than 5%, in particular no more than 2.5%, in particular no more than 1%, of the second center angle FI_MW 3550 of the ARU inner unit 3400 can protrude from the first interior space 3170 in the cross-section. The smaller the proportion of the second center angle FI_MW 3550 that protrudes from the first interior space 3170, the better the fundamental mode of the ARHCF.
2. The second end point—in particular regions thereof—of the ARU inner unit wall 3450 can be arranged on the ARU outer unit wall 3150 of the ARU outer unit 3100 and thus mount the ARU inner unit 3400 completely within the first interior space 3170. In this case, the ARU outer unit 3100 can only be partially integrally bonded to the inner surface 2150 of the cladding 2000. The latter depends upon the proportion of the second center angle FI_MW 3550 which would theoretically additionally be required to establish contact between the first end point and the second end point. In particular, in cross-section, no more than 5%, in particular no more than 2.5%, in particular no more than 1%, of the second center angle FI_MW 3550 may additionally be required to theoretically establish contact between the first end point and the second end point. The smaller the proportion of the second center angle FI_MW 3550 that is required, the better the fundamental mode of the ARHCF.

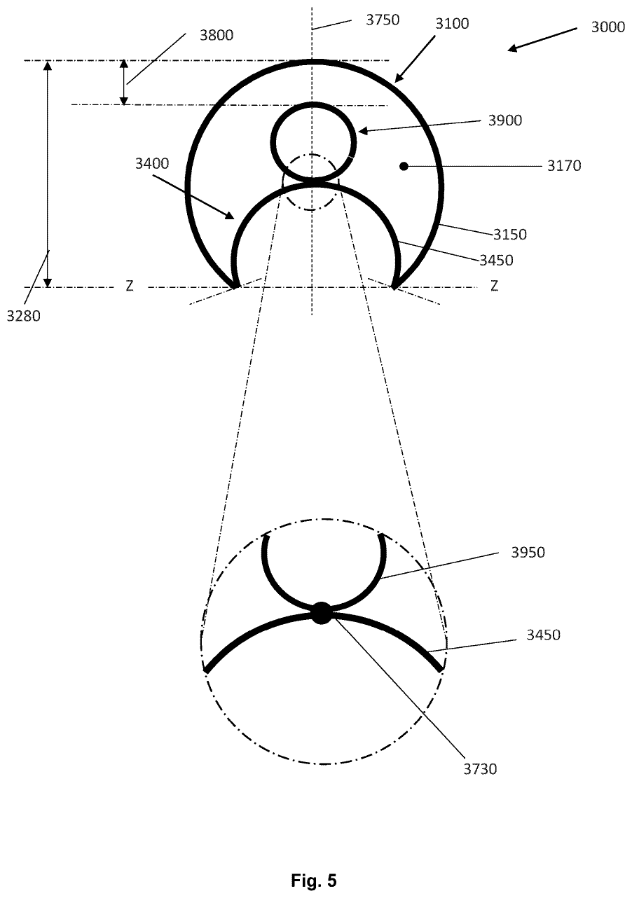

FIG. 5 shows an anti-resonant unit 3000, comprising the circular-arc-like ARU outer unit 3100 and the circular-arc-like ARU inner unit 3400—as shown in FIG. 2—supplemented by the ARU arc unit 3900, as shown in FIG. 3. The ARU arc unit 3900 serves as an anti-resonant element to reduce the attenuation and/or waveguide losses of the fundamental mode and, if appropriately designed, can increase attenuation of modes higher in the core.

The circular-arc-like ARU inner unit 3400 and the ARU arc unit 3900 are connected to one another along a contact line 3730 arranged substantially in parallel with the first body longitudinal body axis 3110. In particular, this bond may have been achieved by a hot process. In one embodiment variant, the contact line 3730 is arranged on the ARU inner unit 3400 such that a distance between the contact line 3730 and the first chord is as large as possible.

The ARU outer unit 3100 has a first interior space 3170 which is at least partially delimited by the ARU outer unit wall 3150. The ARU arc unit 3900 is arranged in the first interior space 3170.

As FIG. 5 illustrates, the anti-resonant unit 3000 has a fiber space height FH_Z1 3800. This fiber space height FH_Z1 3800 describes the shortest length of a straight line that runs between the vertices of the ARU outer unit 3100 and the ARU arc unit 3900. In one embodiment variant, the fiber space height FH_Z1 3800 can be perpendicular to the first chord and run up to the vertex of the ARU outer unit wall 3150. The fiber space height FH_Z1 3800 describes the free space between the ARU outer unit 3100 and the ARU arc unit 3900.

The three body longitudinal axes of the ARU outer unit 3100, the ARU inner unit 3400, and the ARU arc unit 3900 can substantially lie on a straight line 3750. Lateral deviations of each of said body longitudinal axes from the straight line 3750 are limited in particular by manufacturing-related tolerances; in particular the deviation is less than 5%, in particular less than 2.5%, in particular less than 1%, of the first circle radius FA_R.

To illustrate this, a region around the connection seam 3730 is shown enlarged in FIG. 5. The connection is formed between
a point on the ARU inner unit wall 3450 of the ARU inner unit 3400, and
a point on the arc wall 3950 of the ARU arc unit 3900.

Since FIG. 5 shows a cross-section, the contact seam 3730 in the three-dimensional anti-resonant unit 3000 runs into the plane of the drawing.

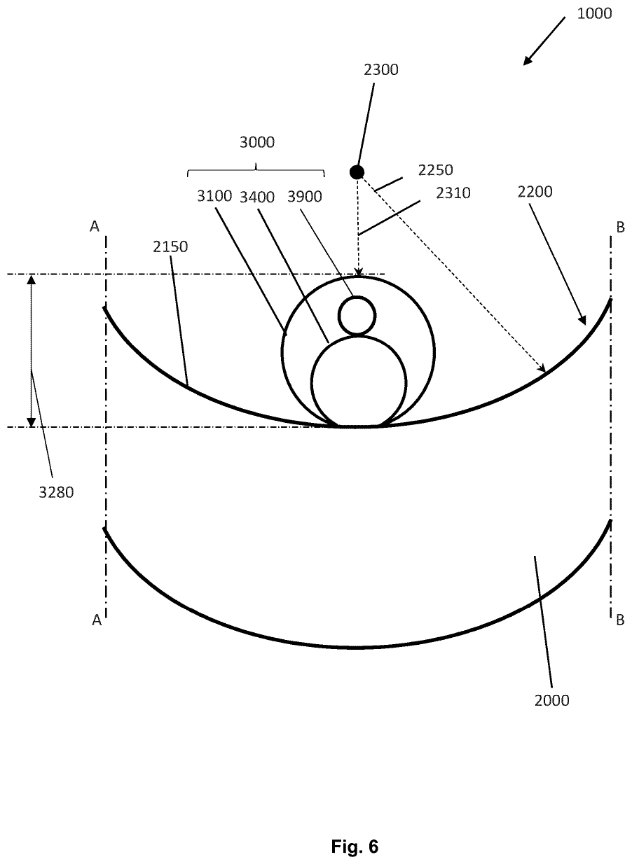

FIG. 6 shows a cross-section through a part of an anti-resonant hollow-core fiber 1000. Shown is a portion of the anti-resonant hollow core fiber 1000 between two intersection lines A-A and B-B. The anti-resonant hollow core fiber 2400 has a cladding 2000. The cladding 2000 can be constructed from an elongated sheath tube in combination with an elongated cladding material. Since, in the embodiment variant illustrated, the cladding material and the sheath tube material are identical, the transition between the two materials is not marked. The cladding 2000 has a cladding inner radius 2250, which results from the distance between the fiber longitudinal axis 2300 of the anti-resonant hollow core fiber 1000 and an inner surface 2150. An anti-resonant unit 3000 is arranged on the inner surface 2150 and is integrally bonded to the inner surface 2150 of the cladding 2000.

Both the ARU outer unit 3100 and the ARU inner unit 3400 are circular-arc-like. Deviations of the ARU outer unit wall 3150 and/or the ARU inner unit wall 3450 from the ideal circular-arc shape are based in particular upon manufacturing-related variations. In particular, the first circle radius FA_R 3200 and/or the second circle radius FI_R 3500 in the ARHCF may not deviate by more than 10%, in particular not more than 5%, in particular not more than 2.5%, from the mean first circle radius FA_R 3200 and/or mean second circle radius FI_R 3500, in particular both azimuthally over a circular arc—so that an elliptical course is created—and at axially different points of the ARHCF.

The ARU arc unit 3900 is circular. Deviations of the radius FB_R 3920 of the ARU arc unit 3900 from the ideal circular shape are based in particular upon manufacturing-related variations. In particular, the radius FB_R 3920 of the ARU arc unit 3900 may not deviate by more than 10%, in particular not more than 5%, in particular not more than 2.5%, from the mean radius FB_R 3920 of the ARU arc unit 3900, in particular both azimuthally over a circle—so that an elliptical course is created—and at axially different points of the ARHCF.

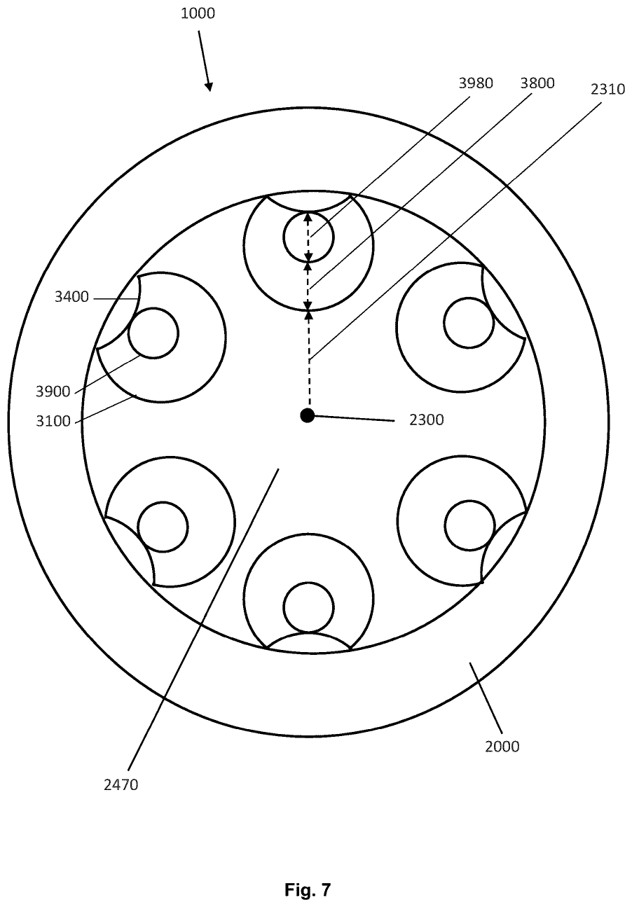

FIG. 7 shows a cross-section through the anti-resonant hollow core fiber 1000. The anti-resonant hollow core fiber 1000 has a hollow core 2470. An electromagnetic wave can propagate through the hollow core 2470. The hollow core fiber 1000 has a core radius 2310, which results from the shortest distance between the longitudinal axis 2300 of the anti-resonant hollow core fiber 1000 and the ARU outer unit 3100. FIG. 7 illustrates the arrangement of the plurality of anti-resonant units 3000—also referred to as ARU's—on the inner surface 2150 delimiting the hollow core 2470. In one embodiment, the anti-resonant hollow-core fiber 1000 can have three, four, five, six, seven or eight anti-resonance units 3000. In FIG. 7, the anti-resonant hollow core fiber 1000 has six anti-resonant units 3000. In this embodiment variant, the anti-resonant units 3000 are arranged asymmetrically on the inner surface 2150 of cladding 2000.

The anti-resonant hollow core fiber 1000 shown in FIG. 7 is characterized in that an amount by which the first circular radius FA_R 3200 deviates from the second circular radius FI_R 3500 is less than 10% of the first circular radius FA_R 3200.

In the anti-resonant hollow core fiber 1000 shown in FIG. 7, the ARU outer unit 3100 and/or the ARU inner unit 3400 and/or the ARU arc unit 3900 may comprise or consist of a quartz glass. Furthermore, the wall thickness of the ARU outer unit 3100 and/or the ARU inner unit 3400 and/or the ARU arc unit 3900 can be designed on the basis of the wavelength transported in the ARHCF. Therefore, the anti-resonant hollow core fiber 1000 can have a wall thickness of the ARU outer unit 3100 and/or the ARU inner unit 3400 and/or the ARU arc unit 3900 of between 0.35 μm and 0.65 μm, in particular between 0.4 μm and 0.6 μm, for a signal wavelength of 1,550 nm. If the anti-resonant hollow core fiber 1000 is to be operated at a signal wavelength of 1,550 nm in the second transmission window, the wall thickness of the ARU outer unit 3100 and/or the ARU inner unit 3400 and/or the ARU arc unit 3900 can be between 1.25 μm and 0.75 μm, in particular between 1.1 μm and 0.9 μm.

In particular, the wall thickness of the ARU outer unit 3100 and the ARU inner unit 3400 and the ARU arc unit 3900 can be substantially the same. In particular, the wall thickness of the ARU outer unit 3100 and the ARU inner unit 3400 and the ARU arc unit 3900 may differ by less than 10%, in particular less than 5%, from the wall thickness of the ARU outer unit 3100.

The anti-resonant hollow core fiber 1000 shown in FIG. 7 can further be characterized in that the fiber core radius R_Faser 2310 is less than 30 μm, in particular less than 25 μm and in particular less than 20 μm. Furthermore, the anti-resonant hollow core fiber 1000 can be characterized in that the fiber core radius R_Faser 2310 is greater than 5 μm, in particular greater than 10 μm, in particular greater than 15 μm. In particular, the anti-resonant hollow core fiber 1000 can have a fiber core radius R_Faser 2310 of 17.25 μm. In particular, the anti-resonant hollow core fiber 1000 can have a fiber core radius R_Faser 2310 of 17.25 μm.

In an embodiment variant of the anti-resonant hollow core fiber 1000, the first circle radius FA_R 3200 can be less than or equal to 15.75 μm and greater than or equal to 12.25 μm.

FIG. 7 illustrates a few parameters describing the arrangement of some of the geometry of the anti-resonant hollow core fiber 1000:
the diameter FB_D 3980 of the ARU arc unit 3900, i.e., twice the radius FB_R 3920 of the ARU arc unit 3900,
the fiber space height FH_Z1 3800 of the anti-resonant unit 3000, which describes the shortest distance between the vertices of the ARU outer unit 3100 and the ARU arc unit 3900, and
the core radius 2310 of the anti-resonant hollow core fiber 1000, which describes the shortest distance between the longitudinal axis 2300 and the ARU outer unit 3100.

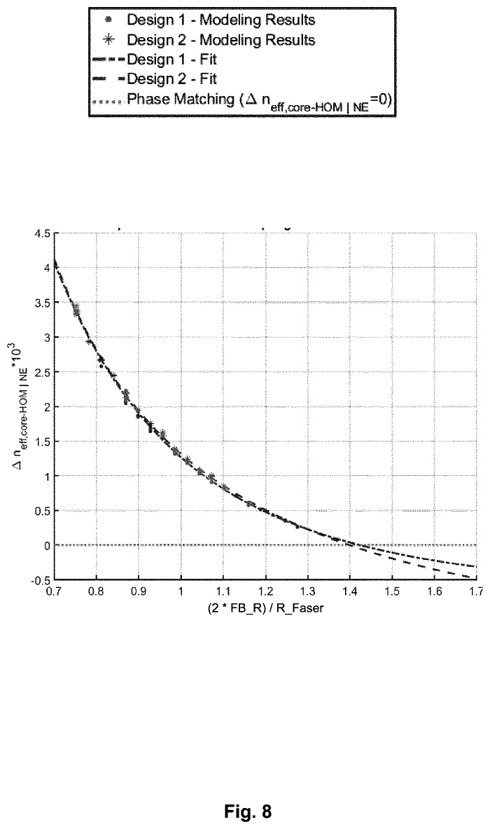

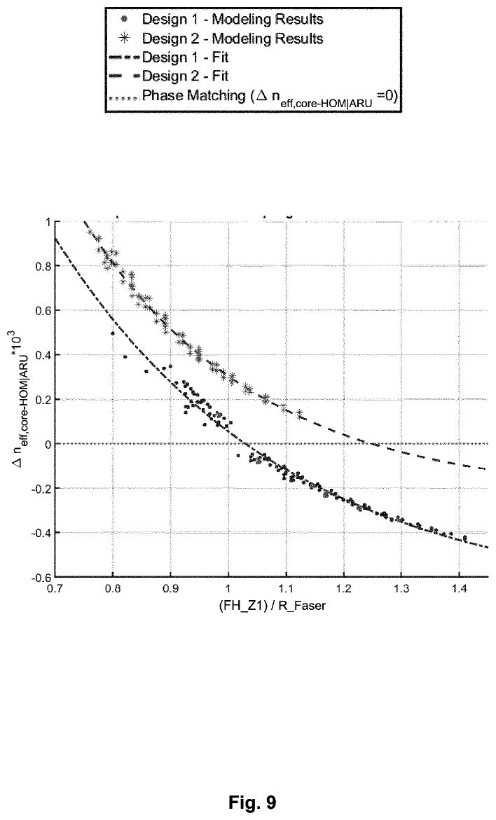

FIGS. 8 to 12 show the results of simulations of an anti-resonant hollow core fiber 1000 having ARU arc units. The finite element method COMSOL Mode Solver was used for the numerical calculations. A perfectly matched layer (PML) with a thickness of 10 μm was implemented at the outer interface of the optical fiber in order to investigate the radiation properties of the waveguide structure by absorbing the radially emitted light energy.

The starting point for the simulations was an anti-resonant hollow core fiber 1000, which is constructed analogously to the anti-resonant hollow core fiber 1000 shown in FIG. 7. This anti-resonant hollow core fiber 1000 comprises a fiber cladding 2000 having a fiber core radius R_Faser 2310. Furthermore, the anti-resonant hollow core fiber 1000 comprises six anti-resonant units 3000,
each comprising an ARU outer unit 3100 and an ARU inner unit 3400,
wherein the circular-arc-like ARU outer unit 3100 and the circular-arc-like ARU inner unit 3400 are interconnected along two seam lines 3700, 3700′ in such a way that the ARU inner unit 3400 projects at least partially into a first interior space 3170 of the ARU outer unit 3100.

In each of the anti-resonant units 3000,
an ARU arc unit 3900 is arranged in the first interior space 3170, wherein
the ARU arc unit 3900 is circular, and
the ARU arc unit 3900 is connected to the ARU inner unit 3400 along a contact seam 3730.

The anti-resonant units have a wall thickness of 500 nm, which in particular corresponds to a wide transmission range (1st transmission band) around the signal wavelength of 1,550 nm. Two designs were used to simulate the anti-resonant hollow core fiber 1000. These two designs differ in that
in Design 1, the first circle radius FA_R is 15.75 μm, and
in Design 2, the first circle radius FA_R is 12.25 μm.

The second circle radius FI_R corresponds to the first circle radius FA_R. All other parameters were identical in both designs. These and other parameters of the simulated anti-resonant hollow core fiber 1000 can be found in Table 1.

TABLE 1
Parameters of the simulated anti-resonant hollow core fiber 1000

| Parameter | Design 1 | | Design 2 | |
|---|---|---|---|---|
| First circle radius FA_R | 15.75 | μm | 12.25 | μm |
| Second circle radius FI_R | 15.75 | μm | 12.25 | μm |
| Fiber core radius R_Faser | 17.25 | μm | 17.25 | μm |
| Number of anti-resonant units | 6 | | 6 | |
| Wall thicknesses of the ARU outer unit, | 500 | nm | 500 | nm |
| ARU inner unit, and ARU arc unit | | | | |
| Simulation range of the ARU arc unit | 5-22 | μm | 1.5-19 | μm |
| diameter | | | | |
| Wall thickness at the contact line 3730 of | 750 | nm | 750 | nm |
| the ARU inner unit and ARU arc unit | | | | |
| Distance between fiber longitudinal axis | 33 | μm | 29.5 | μm |
| 2300 and first body longitudinal axis 3110 | | | | |
| Chord length between connecting lines | 11-26.5 | μm | 8-20 | μm |
| 3700, 3700' | | | | |
| Smallest distance between adjacent anti- | 1.5 | μm | 5 | μm |
| resonant units | | | | |

The following modes were taken into consideration for the simulation:
fundamental mode in the core
   also called core fundamental modes;
higher-order modes in the core
   also called higher-order core modes (HOM),
   wherein, in the simulations, only the second-order modes (i.e., the first-order modes above the fundamental mode) were taken into consideration, as third-order and higher-order modes typically have even higher waveguiding losses and are therefore less relevant when considering the fundamental mode, which is predominantly determined by the power and the waveguiding losses in the second-order modes;
modes in the ARU outer unit
   also called anti-resonant unit modes or ARU modes, which propagate within the first interior space 3170 of the ARU outer unit,
   wherein, in the simulations, only the fundamental mode in the ARU outer units was taken into consideration;
modes in the ARU arc unit
   also called arc unit modes or DNE modes, which propagate within the third interior space 3970 of the ARU arc unit,
   wherein, in the simulations, only the fundamental mode in the ARU arc units was taken into consideration.

The parameters used in FIGS. 8 to 11 are explained in more detail below.

The effective mode index neff indicates the phase velocity of each mode in the propagation direction along the fiber axis by means of the relation vₚₕₐₛₑ=c/n_{eff}, where c denotes the speed of light in vacuo.

The effective mode index difference Δn_{eff} (ARU) denotes the difference between the effective mode index of the higher-order modes in the core and the effective mode index of the anti-resonant modes (ARU modes):

$$Δ {n}_{eff} ( ARU ) = {n}_{eff , core - HOM} - {n}_{eff , ARU mode} .$$

Δn_{eff} (DNE) equivalently exists as the difference between the effective mode index of the higher-order modes in the core and the effective mode index of the arc unit modes (DNE mode):

$$Δ {n}_{eff} ( DNE ) = {n}_{eff , core - HOM} - {n}_{eff , DNE mode} .$$

If the difference Δ n_{eff} in both said cases is close to zero, each of the modes propagate with approximately the same phase propagation velocity and can thus couple coherently (in-phase), which leads to effective energy coupling. In this case, the energy of the higher-order core mode couples into highly lossy ARU or DNE modes. Thus, energy from the higher-order core modes migrates, which leads to an improvement in the fundamental mode.

In the simulation, the effective mode index n_{eff} was extracted from the propagation constant β of the respective mode. A mode “j” is a solution of the physical system of equations:

$${E}_{j} ( x , y , z , t ) = {amplitude}_{j} ( x , y ) ⋆ exp ( i * ( {β}_{j} * z - ω * t ) ) .$$

Here,
Eⱼ(x,y,z,t) describes the electric field distribution in the three spatial dimensions x,y,z at time t,
amplitudeⱼ(x,y) describes the transverse electric field distribution.

Consequently, the propagation constant β describes the phase properties of the wave propagation along the fiber axis z. On the basis of the wavelength of the light A, n_{eff} for mode “j” is directly obtained from β:

$${β}_{j} = 2 * pi / λ * {n}_{eff , j}$$

The propagation constant of the j-th mode—βⱼ—is generally a complex parameter as a solution to the simulation. While the real part yields n_eff,j, the waveguide losses, which were determined for the core modes, can be derived from the imaginary part. The parameter βⱼ therefore contains all the properties that are essential here.

The aforementioned disadvantages of known ARHCF's are also overcome, in particular, when a fast fundamental mode is achieved. This is intended to express that the higher-order modes are attenuated in the core, and the anti-resonant hollow core fiber effectively behaves as in fundamental mode after a shorter travel distance. The shorter this travel distance, the higher the fundamental mode. The physical background is that the energy of the higher-order modes in the core couples into the ARU modes and/or DNE modes, which are more lossy. This means that the higher-order modes no longer make a disruptive contribution to the light signal transmission in the core.

The simulation of the anti-resonant hollow core fiber 1000 surprisingly showed that the geometry of the ARU arc unit 3900 influences the fundamental mode. In particular, the ratio of twice the radius of the ARU arc unit FB_R 3920 to the fiber core radius R_Faser 2310 has proven to be essential.

In FIG. 8, the effective mode index difference Δ n_{eff} (DNE) is plotted against the ratio of twice the radius of the ARU arc unit FB_R 3920 to the fiber core radius R_Faser 2310, in which the
results indicated as dots are plotted for Δn_{eff} (DNE) on the basis of Design 1, and
results indicated as stars are plotted for Δn_{eff} (DNE) on the basis of Design 2.

A curve was fitted to both sets of results using curve fitting.

A Δn_{eff} (DNE) with a small magnitude, which indicates effective energy coupling through adapted phase propagation velocities between the associated modes, is desirable. The differences between Design 1 and Design 2 do not lead to strong variations in the results calculated for Δn_{eff} (DNE) each time. Rather, the two curve fits are very close to, or even on top of, one another. A small Δn_{eff} (DNE) is achieved if-especially for a first circle radius FA_R of between 12.25 μm and 15.75 μm—the following applies for the ratio of twice the radius of the ARU arc unit FB_R 3920 to the fiber core radius R_Faser 2310:

$$\frac{2 * FB\_R}{R\_Faser} = [ 0.7 ; 1.7 ]$$

In addition, this embodiment variant allows for more flexibility to optimally adjust the coupling between the ARU modes and/or DNE modes with the higher-order core modes by specifying a reasonable geometry space.

A further positive influence on the difference in phase propagation velocities can be achieved if, for the ratio of twice the radius of the ARU arc unit FB_R 3920 to the fiber core radius R_Faser 2310, the following applies:
2*FB_R/R_Faser is greater than or equal to 0.8, in particular greater than or equal to 0.9, in particular greater than or equal to 1.0; and
2*FB_R/R_Faser is less than or equal to 1.6, in particular less than or equal to 1.5, in particular less than or equal to 1.45.

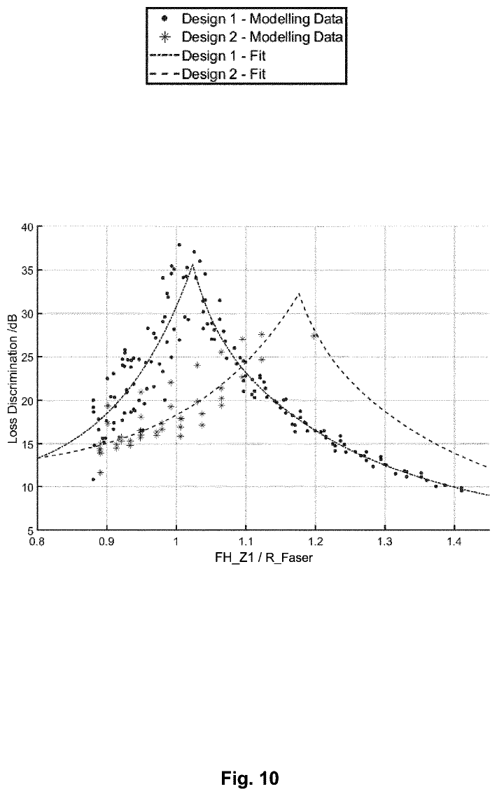

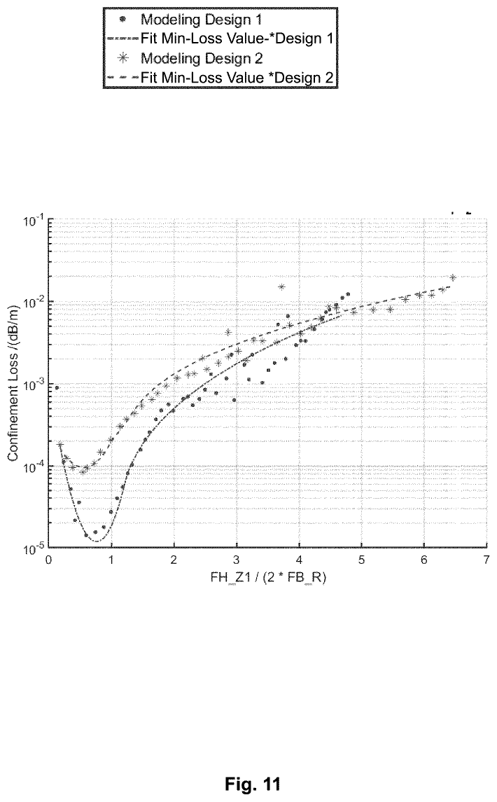

During the simulation of the anti-resonant hollow core fiber 1000, it was surprisingly shown that the geometry of the ARU arc unit 3900 in relation to the geometry of the ARU outer units influences the fundamental mode. In particular, the ratio of the fiber space height FH_Z1 3800 to the fiber core radius R_Faser 2310 is important. FIGS. 9 and 10 illustrate the positive properties of this ratio.

In FIG. 9, the effective mode index Δ neff (ARU) for the two designs is plotted against the ratio of the fiber space height FH_Z1 3800 to the fiber core radius R_Faser 2310, in which the
results indicated as dots are plotted for Δn_{eff} (ARU) on the basis of Design 1, and
results indicated as stars are plotted for Δn_{eff} (ARU) on the basis of Design 2.

A curve was fitted to both sets of results using curve fitting.

As FIG. 9 shows, in Design 1, the fundamental mode is achieved at smaller ratios of the fiber space height to the fiber core radius than in Design 2. In this respect, a fast fundamental mode is achieved in Design 1 if the following applies for the ratio of the fiber space height FH_Z1 3800 to the fiber core radius R_Faser 2310:

$$\frac{FH\_Z1}{R\_Faser} = [ 0.8 ; 1.3 ]$$

As FIG. 9 shows, in Design 2, the fundamental mode is achieved at larger ratios of the fiber space height to the fiber core radius than in Design 1. In this respect, a fast fundamental mode is achieved in Design 2 if the following applies for the ratio of the fiber space height FH_Z1 3800 to the fiber core radius R_Faser 2310:

$$\frac{FH\_Z1}{R\_Faser} = [ 1.0 ; 1.4 ]$$

In combination therewith, a first circle radius FA_R of between 12.25 μm and 15.75 μm in one embodiment variant in particular spans a space for the ratio of the fiber space height FH_Z1 3800 to fiber core radius R_Faser 2310:

$$\frac{FH\_Z1}{R\_Faser} = [ 0.8 ; 1.4 ]$$

A further positive influence on the coupling of the phase propagation velocity can be achieved if—especially for a first circle radius FA_R of between 12.25 μm and 15.75 μm—the following applies for the ratio of the fiber space height FH_Z1 to fiber core radius R_Faser:
FH_Z1/R_Faser is greater than or equal to 0.8, in particular greater than or equal to 0.85, in particular greater than or equal to 0.9, in particular greater than or equal to 0.95, in particular greater than or equal to 1.0, and
FH_Z1/R_Faser is less than or equal to 1.4, in particular less than or equal to 1.35, in particular less than or equal to 1.3, in particular less than or equal to 1.2.

In FIG. 10, the differences in the waveguide losses (also called loss discrimination, LM or waveguide loss differences) between the fundamental mode and the higher-order modes in the core for the two hollow core fiber designs are plotted against the ratio of the fiber space height FH_Z1 to the fiber core radius R_Faser. The waveguide loss differences are defined as follows:

$$LM ( FM vs HOM ) = 10 * {log}_{10} ( HOM attenuation / FM attenuation ) .$$

In this connection, the term attenuation refers exclusively to the calculated waveguide losses of each mode, in which the
results indicated as dots are plotted for the waveguide loss differences on the basis of Design 1, and
results indicated as stars are plotted for the waveguide loss differences on the basis of Design 2.

A curve was fitted to both sets of results using curve fitting, which has the shape of a resonance curve. High loss discrimination values indicate a high difference in waveguide losses between the fundamental mode and higher-order modes and are therefore desirable for a fundamental mode achieved over a short travel distance.

As FIG. 10 illustrates, a hollow core fiber having Design 1 achieves the maximum waveguide loss difference when the following applies for the ratio of the fiber space height FH_Z1 to the fiber core radius R_Faser:

$$\frac{FH\_Z1}{R\_Faser} = [ 0.9 ; 1.2 ]$$

As FIG. 10 further illustrates, a hollow core fiber having Design 2 achieves the maximum waveguide loss difference when the following applies for the ratio of the fiber space height FH_Z1 to the fiber core radius R_Faser:

$$\frac{FH\_Z1}{R\_Faser} = [ 1.0 ; 1.3 ]$$

In combination therewith, a hollow core fiber whose first circular radius FA_R is between 12.25 μm and 15.75 μm achieves, in one embodiment variant, the maximum waveguide loss difference if the following applies for the ratio of the fiber space height FH_Z1 to the fiber core radius R_Faser:

$$\frac{FH\_Z1}{R\_Faser} = [ 0.9 ; 1.3 ]$$

The simulation of the anti-resonant hollow core fiber also surprisingly showed that the geometry of the anti-resonant units, especially the ARU arc units, influences the attenuation of the ARHCF, which is illustrated in FIG. 11.

In FIG. 11, for both designs, the confinement loss (also called waveguide loss or waveguiding loss) of the fundamental mode at a wavelength of 1,550 nm is plotted against the ratio of the fiber space height FH_Z1 3800 to twice the radius of the ARU arc unit FB_R 3920, in which the
results indicated as dots are plotted for the waveguide losses on the basis of Design 1, and
results indicated as stars are plotted for the waveguide losses on the basis of Design 2.

A curve was fitted to both sets of results using curve fitting.

As FIG. 11 shows, low attenuation is achieved, which overcomes at least some of the disadvantages mentioned above, if, in Design 1, the following applies for the ratio of the fiber space height FH_Z1 3800 to twice the radius of the ARU arc unit FB_R 3920:

$$\frac{FH\_Z1}{2 * FB\_R} \leq 2.5$$

A further positive influence on the attenuation can be achieved in Design 1 if the following applies for the ratio of the fiber space height FH_Z1 3800 to twice the radius of the ARU arc unit FB_R 3920:

$$\frac{FH\_Z1}{2 * FB\_R} = [ 0.1 ; 1.2 ]$$

As FIG. 11 shows, low attenuation is achieved, which overcomes at least some of the disadvantages mentioned above, if, in Design 2, the following applies for the ratio of the fiber space height FH_Z1 3800 to twice the radius of the ARU arc unit FB_R 3920:

$$\frac{FH\_Z1}{2 * FB\_R} \leq 1.3$$

A further positive influence on the attenuation can be achieved in Design 2 if the following applies for the ratio of the fiber space height FH_Z1 3800 to twice the radius of the ARU arc unit FB_R 3920:

$$\frac{FH\_Z1}{2 * FB\_R} = [ 0.15 ; 1.0 ]$$

In an embodiment variant illustrated by FIG. 11, a first circle radius FA_R of between 12.25 μm and 15.75 μm spans a space for a design of an ARHCF with low attenuation if the following applies for the ratio of the fiber room height FH_Z1 3800 to twice the radius of the ARU arc unit FB_R 3920:

$$\frac{FH\_Z1}{2 * FB\_R} = [ 0.125 ; 1.05 ]$$

The ARU arc units described in this embodiment variant are the reason why.
the fundamental mode in the core almost does not couple with the DNE modes, but at the same time
the higher-order modes in the core are effectively coupled with the more lossy arc unit modes.

This results in an ARHCF which, on the one hand, enters the fundamental mode over a short distance and, on the other, has only low attenuation of the fundamental mode.

Another embodiment variant is characterized in that, for the ratio of the fiber space height FH_Z1 3800 to twice the radius of the ARU arc unit FB_R 3920, the following applies:
FH_Z1/(2*FB_R) is less than or equal to 1.2, in particular less than or equal to 1.05, in particular less than or equal to 1.0, in particular less than or equal to 0.9, in particular less than or equal to 0.85, in particular less than or equal to 0.8; and
FH_Z1/(2*FB_R) is greater than or equal to 0.1, in particular greater than or equal to 0.125, in particular greater than or equal to 0.15, in particular greater than or equal to 0.2, in particular greater than or equal to 0.4, in particular greater than or equal to 0.5.

This embodiment variant is characterized by a positive influence on the attenuation.

The anti-resonant hollow core fiber 1000 is characterized in that an amount by which the first circular radius FA_R 3200 deviates from the second circular radius FI_R 3500 is less than 10% of the first circular radius FA_R 3200. To determine the effects of these differences in the two circular radii on the fundamental mode, simulations were performed for two additional designs of the anti-resonant hollow core fiber 1000. Table 2 shows the parameters that differ for the simulated anti-resonant hollow core fiber 1000.

TABLE 2
Parameters of the simulated
anti-resonant hollow core fiber 1000

| Parameter | Design 3 | | Design 4 | |
|---|---|---|---|---|
| first circle radius FA_R | 15.75 | μm | 15.75 | μm |
| second circle radius FI_R | 14.175 | μm | 17.325 | μm |

All other parameters correspond to the parameters listed in Table 1 and/or described in more detail above for the anti-resonant hollow core fiber 1000 according to Design 1. Consequently, two simulations were carried out in which only the second circle radius FI_R was changed by +/−10% with respect to the first circle radius FA_R.

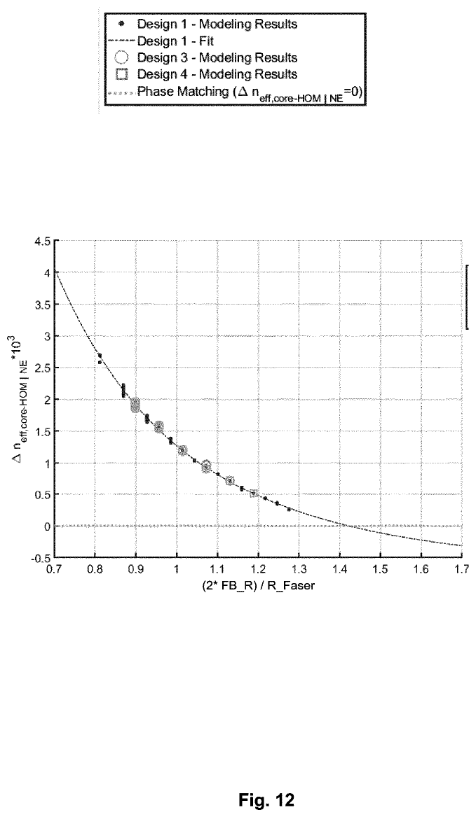

In FIG. 12, the results of this simulation are listed. The effective mode index difference Δ neff (DNE) is plotted against the ratio of twice the radius of the ARU arc unit FB_R 3920 to the fiber core radius R_Faser 2310, in which the
results indicated by dots are plotted for Δn_{eff} (DNE) on the basis of Design 1, which are identical to those in FIG. 8,
results indicated by circles are plotted for Δn_{eff} (DNE) on the basis of Design 3, and results indicated by rectangles are plotted for Δn_{eff} (DNE) on the basis of Design 4.

A curve was fitted to the set of results for Design 1 using a curve fitting.

The values calculated for Designs 3 and 4 lie directly on the curve that was fitted to the values for Design 1. In this respect, the first circle radius FA_R 3200 and the second circle radius FI_R 3500 span a space for a design of an ARHCF with low attenuation within a variation of less than or equal to 10% of the first circle radius FA_R 3200.

Reference signs

| | |
|---|---|
| 1000 | anti-resonant hollow-core fiber |
| 2000 | cladding or fiber cladding |
| 2150 | inner side of the cladding |
| 2250 | cladding inner radius |
| 2300 | fiber longitudinal axis |
| 2310 | core radius R_Faser |
| 2470 | hollow core |
| 2980 | first circle |
| 2990 | second circle |
| 3000 | anti-resonant unit (ARU) |
| 3100 | ARU outer unit of the anti-resonant hollow core fiber |
| 3110 | first body longitudinal axis |
| 3150 | ARU outer unit wall |
| 3170 | first interior space of the ARU outer unit |
| 3200 | first circle radius FA_R |
| 3250 | first center angle FA_MW |
| 3280 | first segment height |
| 3290 | first chord length |
| 3400 | ARU inner unit of the anti-resonant hollow core fiber |
| 3410 | second body longitudinal axis |
| 3450 | ARU inner unit wall |
| 3470 | second interior space of the ARU inner unit |
| 3500 | second circle radius FI_R |
| 3550 | second center angle FI_MW |
| 3580 | second segment height F_Innen |
| 3590 | second chord length |
| 3700, | connection seam |
| 3700' | |
| 3730 | contact seam |
| 3800 | fiber space height (FH_Z1) |
| 3900 | ARU arc unit |
| 3910 | first body longitudinal axis |
| 3920 | radius FB_R of the ARU arc unit |
| 3950 | arc wall |
| 3970 | third interior space of the ARU arc unit |
| 3980 | diameter FB_D of the ARU arc unit |

1. An anti-resonant hollow-core fiber, comprising:
a fiber longitudinal axis and a fiber core radius R_Faser,
a fiber cladding which comprises a cladding inner bore,
a number of anti-resonance units,
each comprising an ARU outer unit and an ARU inner unit,
wherein the circular-arc-like ARU outer unit and the circular-arc-like ARU inner unit are interconnected along two seam lines in such a way that the ARU inner unit projects at least partially into a first interior space of the ARU outer unit,
wherein the anti-resonance units are mutually spaced and are arranged so as to have no contact with one another at desired positions on a cladding inner side,
wherein
the ARU outer unit has a first circle radius FA_R and a first center angle FA_MW,
the ARU inner unit has a second circle radius FI_R and a second center angle FI_MW,
wherein an amount of a deviation of the first circle radius FA_R from the second circle radius FI_R is less than 10% of the first circle radius FA_R,
wherein
the first center angle FA_MW is less than 345° and greater than 275°, and
the second center angle FI_MW is less than 195° and greater than 40°,
wherein in at least one anti-resonance unit
an ARU arc unit is arranged in the first interior space,
the ARU arc unit is circular,
has a radius FB_R, and
the ARU arc unit is connected to the ARU inner unit along a contact seam,
wherein
for the ratio of twice the radius of the ARU arc unit FB_R to the fiber core radius R_Faser, the following applies
$$\frac{2 * FB\_R}{R\_Faser} = [ 0.7 ; 1.7 ] .$$

2. The anti-resonant hollow-core fiber according to claim 1, wherein, for the ratio of twice the radius of the ARU arc unit FB_R to the fiber core radius R_Faser, the following applies:
2*FB_R/R_Faser is greater than or equal to 0.8, in particular greater than or equal to 0.9, in particular greater than or equal to 1.0; and
2*FB_R/R_Faser is less than or equal to 1.6, in particular less than or equal to 1.5, in particular less than or equal to 1.45.

3. The anti-resonant hollow-core fiber according to claim 1, wherein the anti-resonance unit has a fiber space height FH_Z1, and, for the ratio of the fiber space height FH_Z1 to the fiber core radius R_Faser, the following applies:
$$\frac{FH\_Z1}{R\_Faser} = [ 0.8 ; 1.4 ] .$$

4. The anti-resonant hollow-core fiber according to claim 3, wherein, for the ratio of the fiber space height FH_Z1 to the fiber core radius R_Faser, the following applies:
FH_Z1/R_Faser is greater than or equal to 0.8, in particular greater than or equal to 0.85, in particular greater than or equal to 0.9, in particular greater than or equal to 0.95, in particular greater than or equal to 1.0, and
FH_Z1/R_Faser is less than or equal to 1.4, in particular less than or equal to 1.35, in particular less than or equal to 1.3, in particular less than or equal to 1.2.

5. The anti-resonant hollow-core fiber according to claim 1, wherein, for the ratio of the fiber space height FH_Z1 to twice the radius of the ARU arc unit FB_R, the following applies:
$$\frac{FH\_Z1}{2 * FB\_R} \leq 2.5 , in particular \leq 1.3 .$$

6. The anti-resonant hollow-core fiber according to claim 5, wherein, for the ratio of the fiber space height FH_Z1 to twice the radius of the ARU arc unit FB_R, the following applies:
FH_Z1/is less than or equal to 1.2, in particular less than or equal to 1.05, in particular less than or equal to 1.0, in particular less than or equal to 0.9, in particular less than or equal to 0.85, in particular less than or equal to 0.8; and
FH_Z1/is greater than or equal to 0.1, in particular greater than or equal to 0.125, in particular greater than or equal to 0.15, in particular greater than or equal to 0.2, in particular greater than or equal to 0.4, in particular greater than or equal to 0.5.

7. The anti-resonant hollow-core fiber according to claim 1, wherein the amount of the deviation of the first circle radius FA_R from the second circle radius FI_R is less than 5% of the first circle radius FA_R, in particular less than 3%, in particular less than 2%, in particular less than 1%.

8. The anti-resonant hollow-core fiber according to claim 1, wherein the anti-resonant hollow-core fiber comprises three, four, five, six, seven or eight anti-resonance units.

9. The anti-resonant hollow-core fiber according to claim 1, wherein at least one of the anti-resonance units comprises at least one of the following features:
the ARU outer unit and/or the ARU inner unit and/or the ARU arc unit comprises an amorphous solid body, in particular a glass, in particular quartz glass,
the ARU outer unit and/or the ARU inner unit and/or the ARU arc unit consists of an amorphous solid body, in particular a glass, in particular quartz glass,
the ARU outer unit and/or the ARU inner unit and/or the ARU arc unit are made of the same material, in particular comprise or consist of a glass having a refractive index of at least 1.4, in particular 1.4 to 3, in particular 1.4 to 2.8, and
a wall thickness of the ARU outer unit and the ARU inner unit and the ARU arc unit are substantially the same.

10. The anti-resonant hollow-core fiber according to claim 1, wherein the anti-resonant hollow-core fiber comprises at least one of the following features:
a fundamental attenuation of less than 1.0 dB/km, in particular of less than 0.5 dB/km, in particular of less than 0.25 dB/km, in particular less than 0.15 dB/km for a transported wavelength between 1.0 μm and 2.5 μm, and
a fundamental attenuation of less than 1 dB/km for a transported wavelength of up to 0.8 μm.

11. The anti-resonant hollow-core fiber according to claim 1, wherein, for the first circle radius F_R and/or second circle radius FI_R, the following applies:
this is less than 30 μm, in particular less than 20 μm, in particular less than 17.5 μm, in particular less than or equal to 16.5 μm, in particular less than or equal to 15.75 μm, and/or
this is greater than 5 μm, in particular greater than 10 μm, in particular greater than or equal to 11.5 μm, in particular greater than or equal to 12.25 μm.

12. The anti-resonant hollow-core fiber according to claim 1, wherein at least one ARU arc unit comprises at least one of the following features:
the radius of the ARU arc unit FB_R is less than 15 μm, in particular less than 12.5 μm, in particular less than 11 μm, in particular less than 9.5 μm
the radius of the ARU arc unit FB_R is greater than 0.75 μm, in particular greater than 1 μm, in particular greater than 2.5 μm.

13. The anti-resonant hollow-core fiber according to claim 1, wherein at least one of the anti-resonance units comprises at least one of the following features:
a wall thickness of the ARU outer unit and/or the ARU inner unit and/or the ARU arc unit is between 0.1 μm and 2.5 μm, in particular between 0.15 μm and 1.5 μm, in particular between 0.25 μm and 0.75 μm, in particular between 0.35 μm and 0.65 μm, in particular 0.5 μm,
for a signal wavelength of 1550 nm in the first transmission window, a wall thickness of the ARU outer unit and/or the ARU inner unit and/or the ARU arc unit is between 0.35 μm and 0.65 μm, in particular between 0.4 μm and 0.6 μm, in particular 0.5 μm,
for a signal wavelength of 1550 nm in the second transmission window, a wall thickness of the ARU outer unit and/or the ARU inner unit and/or the ARU arc unit is between 0.75 μm and 1.25 μm, in particular between 0.9 μm and 1.1 μm, in particular 1 μm.
